(19) United States
(12) Patent Application Publication
(10) Pub. No.: US 2004/0103311 A1
(43) Pub. Date: May 27, 2004

(54) Secure wireless mobile communications

(76) Inventors: Melbourne Barton, Somerville, NJ (US); Kuok-Shoong Wong, Eatontown, NJ (US); Mario Joa-Ng, Hong Kong (CN); Derek Atkins, Somerville, MA (US)

Correspondence Address: TELCORDIA TECHNOLOGIES, INC., ONE TELCORDIA DRIVE 5G116, PISCATAWAY, NJ, 08854-4157, US

(21) Appl. No.: 10/305,817

(22) Filed: Nov. 27, 2002

(51) Int. Cl. H04L 9/00

(52) U.S. Cl. 713/201

(57) ABSTRACT

Secure wireless communications for a mobile host over any wireless interface within a wireless network is provided by a security gateway. The security gateway is situated and configured within the mobile host's home network of the wireless network such that it provides the only point of access between the wireless network and the home network. Additionally, the security gateway is separate and distinct from the mobile host's home agent within the home network. A single tunnel mode security association is established between the mobile host's wireless interface and the security gateway's network interface on the home network. This single tunnel mode security association remains established as the mobile host moves between foreign networks and provides secure wireless communications to the mobile host whether the mobile host is in the home network or the foreign networks.

### BACKGROUND OF OUR INVENTION

1. Field of the Invention

Our invention relates generally to secure wireless mobile communications. More particularly, our invention relates to methods and apparatus for enabling a wireless mobile host to maintain secure communications as it moves between wireless interfaces within and across networks.

2. Description of the Background

Mobility in IP (Internet Protocol) networks has become increasingly popular with the advent of IP wireless networks. As popular is the growth of IP-based applications such as e-commerce and remote access that require the transmission of sensitive information such as logins/passwords, credit card numbers, etc. Wireline interfaces inherently provide some degree of security in that an intruder must physically tap the network in order to passively receive another's communications. On the contrary, wireless interfaces are more easily monitored in that an intruder only needs a wireless access device and need only be in the general vicinity of a wireless user. Hence, some form of data security, such as encryption, is needed over the wireless interface. However, this security must be coherently integrated with the mobility aspects of the wireless network. More specifically, a coherent and efficient integration of IP security and IP mobility is needed to secure the wireless interfaces over which mobile devices communicate.

Mobile IP (MIP) is a mobility management scheme developed by the Internet Engineering Task Force (IETF) that allows a mobile host to move between different sub-networks comprising a wireless network. In accordance with MIP, the mobile host is addressed by the same IP address as it moves between the different sub-networks. This IP address unity allows transparent network connectivity, which is essential for non-real-time applications that use connection-oriented protocols such as TCP (transmission control protocol). FIG. 1 shows an exemplary MIP-based wireless network 100. Mobile host 116 is associated with a home network 104 (i.e., a sub-network of network 100) and is assigned a permanent IP address corresponding to this network. All communications between the mobile host and a network device on a backbone/external network 102, such as a correspondent host 108, are based on this permanent IP address regardless of which sub-network the mobile host has moved to. Additionally, the mobile host 116 is associated with a home agent 110 located in the home network 104. This home agent assists the mobile host in maintaining transparent connectivity during mobility.

When the mobile host 116 is located in the home network, all data packets from the correspondent host 108 are addressed to the mobile host at its permanent IP address. These packets are routed to the home agent at an interface 112. The home agent receives and forwards these packets to a second interface 114 and transmits the packets over a wireless interface to the mobile host at an interface 118. Similarly, all data packets from the mobile host to the correspondent host are routed through the home agent.

When the mobile host moves to a foreign network, such as sub-network 106, the mobile host obtains a temporary care-of-address that is used for routing purposes to locate the mobile host. This care-of-address is either associated with a foreign agent 109 or is directly associated with the mobile host, depending on the mode MIP is running under. When the mobile host moves to this foreign network, a registration process occurs in which the home agent 110 is notified of the mobile host's move and of its temporary care-of-address. Importantly, the mobile host continues to maintain its identity by its permanent IP address associated with the home network 104.

While the mobile host 116 is located in the foreign network 106, the correspondent host 108 and the mobile host continue to use the mobile host's permanent IP address when addressing data packets, allowing the mobility to remain transparent to upper layer applications/protocols. As a result, all packets sent by the correspondent host to the mobile host continue to be routed to the home agent 110 at interface 112. However, rather than the home agent now transferring the packets to the mobile host on interface 114, the home agent encapsulates each packet with a new IP header, addressing the packet to the mobile host's temporary care-of-address. As such, the packet is routed or tunneled to the foreign agent 109/mobile host 116 where the temporary header is removed and the packet is processed as though it was directly routed to the mobile host.

Similarly, data packets from the mobile host to the correspondent host are addressed using the permanent IP address. These packets are subsequently routed to the correspondent host either directly or through reverse tunneling. In reverse tunneling, the packet is again encapsulated with a new IP header, addressing the packet to the home agent 110 at interface 112. The home agent receives the packet, removes the header, and forwards the original packet on interface 112 to the correspondent host 108.

The IETF has also developed the IP Security (IPSec) protocol, which addresses security at the IP layer. In particular, IPSec provides encryption for IP packet payloads during transmission. IPSec operates by establishing a security association between two network nodes that require secure communications. A security association is associated with a specific interface on each node and can be viewed as a connection between these two node interfaces that defines specific types of security services provided to traffic that flows over the connection. There are two types of security associations, a transport mode security association and a tunnel mode security association. In transport mode, a sender, prior to transmitting an IP packet, encrypts the data portion of the packet while the IP header is left clear. In tunnel mode, the security association is between an end host and an intermediate gateway, for example, with the security association only covering a portion of the communications path between the end host and another network node with which the end host is communicating. Here, the end host or gateway encrypts an entire packet, including the header, prior to transmission and then encapsulates the packet with a new IP header, tunneling the encrypted packet to the end host or gateway, depending on the direction of transmission. The end host or gateway then removes the encapsulation header and decrypts the original packet. If the packet is being sent towards the gateway from the end host, the gateway then forwards the original packet to the intended network node.

Advantageously, whether transport mode or tunnel mode, a security association exists between two network nodes and one must have this security association to properly encrypt and decrypt data intended to travel between these two nodes. However, the management of these security associations creates an issue for the successful deployment of IPSec. Specifically, in order for IPSec to operate, the two end points must be configured with security association management data and secure keys. This configuration can either be done manually through a system administrator or through an automated system. An automated system is required when IPSec is widely deployed in a network such as the Internet, but such automated systems do not currently exist in an efficient and secure form.

IPSec was originally designed for fixed networks. However, several prior systems have integrated MIP and IPSec to provide security over the wireless interface between a mobile host and the network. In a first solution, a transport mode security association is established between the mobile host and a correspondent host to which the mobile host is communicating. Here, packets transmitted between the mobile host and correspondent host are encrypted on both the wireline and the wireless interfaces, regardless of whether the mobile host is in the home network or a foreign network. Importantly, the security association between the mobile host and the correspondent host does not need to change when the mobile host moves between networks. However, this implementation has two disadvantages. First, the mobile host must maintain a security association with every correspondent host with which it intends to communicate. This can create scalability problems unless an automated distribution system is widely deployed. As indicated earlier, such systems do not currently exist on large scale. Secondly, this implementation assumes all correspondent hosts in the network have IPSec. Currently, IPSec is not common at all end nodes on the Internet.

A second solution is to run IPSec in the home network and in all foreign networks to which the mobile host may visit. Here, IPSec is run on the home agent and all foreign agents to which the mobile host is likely to attach. Specifically, a plurality of unique tunnel mode security associations is created, one for the wireless interface between the mobile host and the home agent and one for each of the wireless interfaces between the mobile host and the foreign agents. Here, the home agent and foreign agents act as gateways (as defined by IPSec). As such, depending on the network to which the mobile host is currently attached, the corresponding security association (for the corresponding home agent or foreign agent) is used, securing all communications over the wireless interface. Advantageously, all wireless communications are secure in this solution, however this solution has two limitations. First, this solution is not scalable since it requires the mobile host to maintain a list of security associations for all possible foreign agents to which it might attach, unless an efficient and secure distribution mechanism is employed. Second, this solution relies on each foreign network to provide IPSec for visiting mobile hosts. Again, these networks may not provide IPSec or if they do, the service may not be trusted.

A third solution is to run IPSec in tunnel mode only between the home agent and the mobile host, with the home agent again acting as a gateway. Here, two tunnel mode security associations are created between the home agent and the mobile host. The first tunnel is between the mobile host and the home agent using the home agent's wireless interface 114. The second tunnel is between the mobile host and the home agent using the home agent's wireline interface 112. Only one of the two IPSec tunnels is configured on the mobile host at a given time. Specifically, when the mobile host is in the home network, the tunnel associated with the home agent's wireless interface 114 is active, thereby providing secure communications over the wireless interface 120. In this mode, the mobile host operates as expected, decrypting encoded packets from the mobile host on the wireless interface and forwarding them on the wireline interface 112. Similarly, packets from the correspondent host arriving on interface 112 for the mobile host are encrypted and forwarded by the home agent to the mobile host on interface 114.

When the mobile host moves to the foreign network 106, the first IPSec tunnel must be disabled and the second IPSec tunnel activated in order to integrate MIP and IPSec. Specifically, as indicated, the first tunnel is associated with the home agent's wireless interface 114. As such, as the home agent receives packets from the correspondent host 108, the home agent will encrypt and attempt to tunnel these packets to the mobile host using the wireless interface 114, precluding the MIP integration. The second security association is associated with the wireline interface 112 and therefore allows integration with MIP. Specifically, as the home agent receives packets from the correspondent host, it encrypts the packet under IPSec and adds the new IPSec header. Prior to sending the packet out the wireline interface 112 of the home agent, the home agent encapsulates the entire IPSec packet with the MIP header and tunnels the packet to the foreign network 106. Once the MIP header is removed, the mobile host removes the IPSec header and decrypts the packet. As such, the packet is encrypted over the wireless interface 122 to the mobile host. For packets originating from the mobile host, the mobile host encrypts the packet using IPSec and adds the IPSec header, tunneling the IPSec packet to the home agent at interface 112. Again, the packet is encrypted over the wireless interface 122. When the home agent receives the packet, it decrypts the packet and forwards it to the correspondent host.

While this third variation overcomes issues inherent in the first and second variations, such as scalability issues, this third variation is not seamless. When the mobile host moves to a foreign network, the MIP registration must take place followed by the establishment of the second IPSec tunnel. The IPSec changeover takes time and creates a delay. During this delay, the mobile host and correspondent host must either cease communicating to prevent unsecured communications or communicate unsecurely until the new IPSec tunnel is established. Similar issues occur when the mobile host returns to the home network 104 from the foreign network 106 and the first IPSec tunnel is re-established.

A fourth solution similar to the third solution is to modify MIP by integrating IPSec into MIP. However, this variation requires changes to MIP making it more difficult to deploy.

### SUMMARY OF OUR INVENTION

Accordingly, it is desirable to have methods and apparatus that provide seamless and scalable security over any wireless interface through which a mobile host may communicate in a wireless network, thereby overcoming the disadvantages of prior solutions. In accordance with our invention, a home network (within the wireless network) to which a mobile host is associated comprises a home agent, which provides the mobile host with mobility management as the mobile host moves between sub-networks, and a security gateway, which is distinct from the home agent and provides secure wireless communications for the mobile host. Specifically, the security gateway of our invention is situated and configured within the home network such that it provides the home network with the only interface to the wireless network, acting as a gateway between the wireless network and the home network. Importantly, the security gateway also provides the mobile host with secure communications as it moves between wireless interfaces within and across wireless networks to which the mobile host may travel.

In accordance with our invention, a single tunnel mode security association is established between the mobile host's wireless interface and the security gateway's network interface on the home network. When the mobile host is in the home network and communicating with a correspondent host, packets originated by the mobile host are encrypted and securely tunneled over the wireless interface to the security gateway, where the security gateway decrypts the packets and forwards the original packets to the correspondent host. Similarly, packets from the correspondent host are routed to the security gateway, where the packets are encrypted and securely transmitted to the mobile host through the secure tunneled. In either direction, the mobile host's wireless interface is secure.

When the mobile host moves to a foreign network, the mobile host registers its mobility with the home agent. However, during this time, the single tunnel mode security association between the mobile host's wireless interface and the security gateway's network interface on the home network remains established. While in the foreign network, packets from the mobile host are encrypted and securely tunneled over the wireless interface in the foreign network to the security gateway. The security gateway decrypts the packets and forwards the original packets to the correspondent host. Packets originating from the correspondent host are routed to the security gateway as before. The security gateway encrypts these packets and securely tunnels the packets onto the home network as if the mobile host were still located in this network. These packets are received by the mobile host, which then encapsulates the packets using a mobility protocol and forwards the packets to the foreign network. At the foreign network, the mobility encapsulation is removed and the packets are securely transferred over the wireless interface to the mobile host where the packets are decrypted. Again, the mobile host's wireless interface is secure in both directions.

Advantageously, in accordance with our inventive security gateway within the home network, the mobile host transmits and receives secure communications over any wireless interface in the wireless network using a single security association. Contrary to other solutions, the mobile host is not required to maintain numerous security associations, thereby overcoming scalability issues of prior solutions. In addition and in accordance with our invention, a single security association is required between the security gateway and the mobile host and this security association remains active regardless of whether the mobile host travels to/from the home network, overcoming delay issues related to prior solutions. Furthermore, our inventive methods and systems do not require modification to mobility protocols. Nor do our inventive methods and systems require modifications to security protocols.

### BRIEF DESCRIPTION OF THE DRAWINGS

FIG. 1 depicts a prior art wireless IP network using the MIP mobility management protocol for managing a mobile host's mobility between the sub-networks of the network.

FIG. 2 is a simplified block diagram of an illustrative embodiment of our invention for providing secure communications for a mobile host over any wireless interface through which the mobile host may communicate in a wireless network, wherein the secure communications occur through a single tunnel mode security association maintained between the mobile host and a security gateway of our invention and wherein this security association remains established throughout the mobile host's mobility within the wireless network.

FIGS. 3A and 3B are a more detailed block diagram of the illustrative embodiment of our invention as shown in FIG. 2 wherein the security gateway is situated within a home network of the mobile host and acts as a gateway for the home network, providing the only point of access between the home network and the wireless network, and wherein the security association that provides the mobile host with network-wide wireless security is between the mobile host's wireless interface and the security gateway's network interface on the home network.

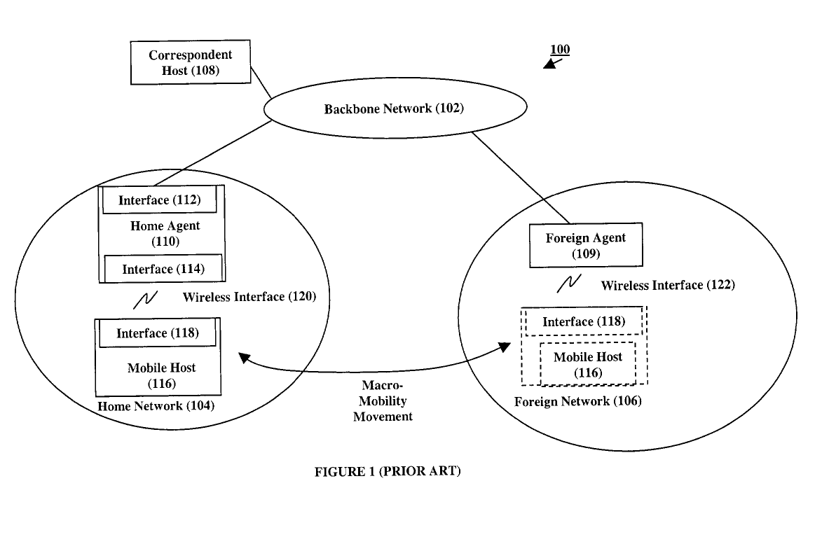

### DETAILED DESCRIPTION OF OUR INVENTION

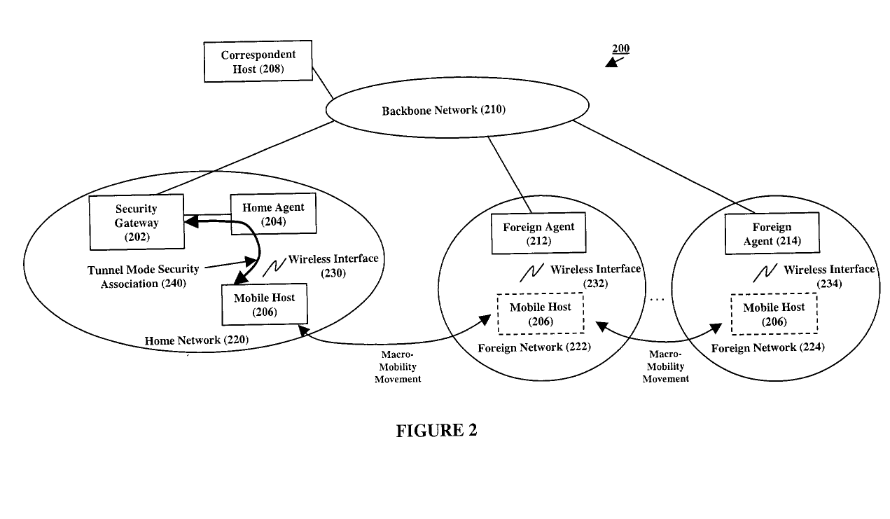

FIG. 2 shows a diagram of a wireless network 200 and security gateway 202 of our invention, gateway 202 providing secure communications for a mobile host 206 as the mobile host moves between wireless interfaces, such as interfaces 230, 232, and 234, both within and across the wireless networks to which mobile host 206 may travel. As shown by FIG. 2, network 200 comprises a plurality of wireless sub-networks 220, 222, and 224 interconnected by a backbone network 210, such as the Internet. In accordance with wireless protocols, such as MIP, a mobile host is associated with a home network and travels to and from foreign networks. As such, from the perspective of the mobile host 206, sub-networks 220, 222, and 224 include a home network 220 to which the mobile host 204 is associated, and a plurality of foreign sub-networks 222 and 224 to which the mobile host 206 may travel. Home network 220 comprises a home agent 204 that provides a wireless point of access to network 200 for the mobile host 206, acts as a gateway for the mobile host, passing packets between network 200 and the mobile host, and provides the mobile host with mobility management as the mobile host moves to foreign networks. Similarly, each foreign network comprises a foreign agent 212 and 214 that provides a wireless point of access to network 200 as the mobile host 206 moves to the foreign network, acts as a gateway for the mobile host, and provides the mobile host with mobility management as the mobile host moves to the foreign network.

In accordance with our invention, home network 220 further comprises the security gateway 202 that is distinct from the home agent 204. Importantly, the security gateway is situated and configured within the home network 220 such that it provides home network 220 with the only interface to backbone network 210, routing all packets between the home network and the backbone network. As such, all data packets from the external network (i.e. the backbone network 220 and foreign networks 222 and 224) to and from the home network (including the home agent 204 and mobile host 206) must pass through the security gateway 202. As important, the security gateway also provides secure communications over any wireless interface 230, 232, and 234 for each mobile host associated with the home network 220 regardless of whether the mobile host is in home network 220 or a foreign network 222 and 224 (only one mobile host 206 is shown in FIG. 2). Specifically, for each mobile host 206 associated with home network 220 that requests/requires secure wireless communications over a wireless interface 230, 232, or 234, a single tunnel mode security association 240 is established between the mobile host and the security gateway 202, this single security association providing mobile host 206 with secure communications over any wireless interface 230, 232, and 234 whether the mobile host is located in the home network 220 or moves to a foreign network 222 and 224. Note that while the security gateway 202 is being described with respect to a single home network/home agent with a set of associated mobile hosts, in accordance with our invention security gateway 202 can be associated with a plurality of home networks/home agents each with a set of associated mobile hosts.

Before describing our invention in greater detail, it should be noted that our inventive methods for providing security over wireless interfaces are being described with respect to macro-mobility management, which allows mobile hosts to perform mobility between sub-networks (e.g., between home network 220 and foreign networks 222 and 224). However, wireless access networks are being proposed to now include both macro-mobility and micro-mobility management. In these networks, the network comprises interconnected micro-mobility regions/domains each with numerous wireless access points. As above, each mobile host has a home domain. While moving between access points within a domain (i.e., micro-mobility movement), a mobile host maintains a single IP address and registration with a home agent, as occurs with MIP, never occurs. A micro-mobility protocol, such as HAWAII and Cellular-IP, maintains the domain such that packets can be properly routed within the domain to/from the mobile host. However, whenever a mobile host moves between domains (i.e., macro-mobility movement), the mobile host must obtain a new IP address and registration is performed with the home agent through MIP, for example. In accordance with our invention, a security gateway 202 resides between a micro-mobility domain and the external network and a mobile host based out of that domain maintains a single tunnel mode security association with the security gateway. This security association provides the mobile host with secure wireless communications as the mobile host moves between wireless interfaces within across the home domain and foreign domains.

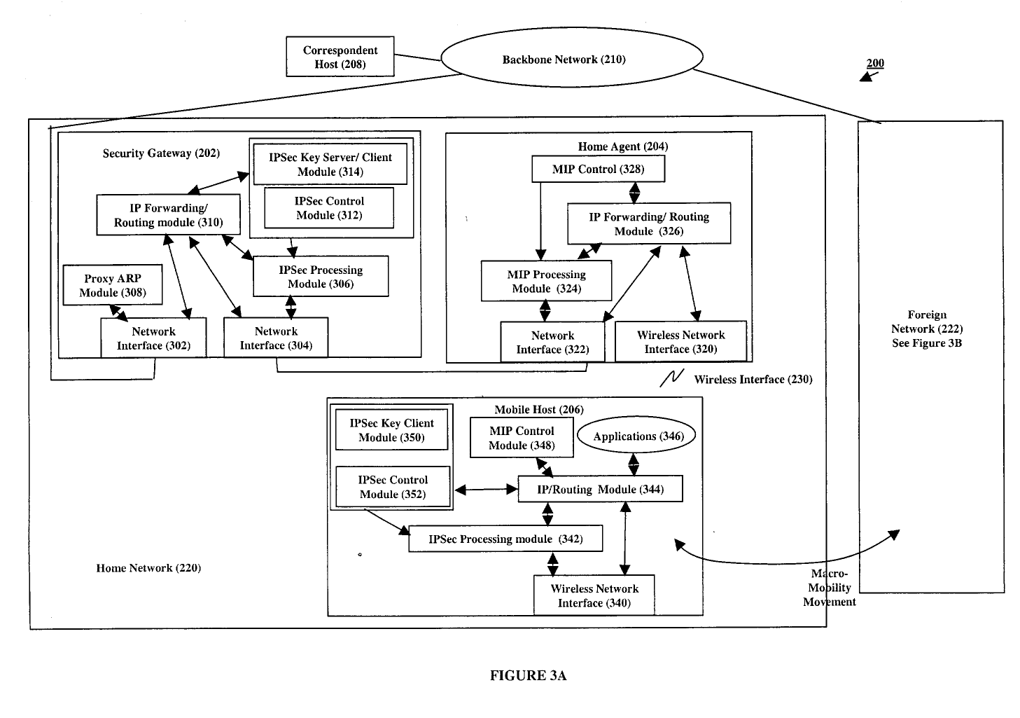

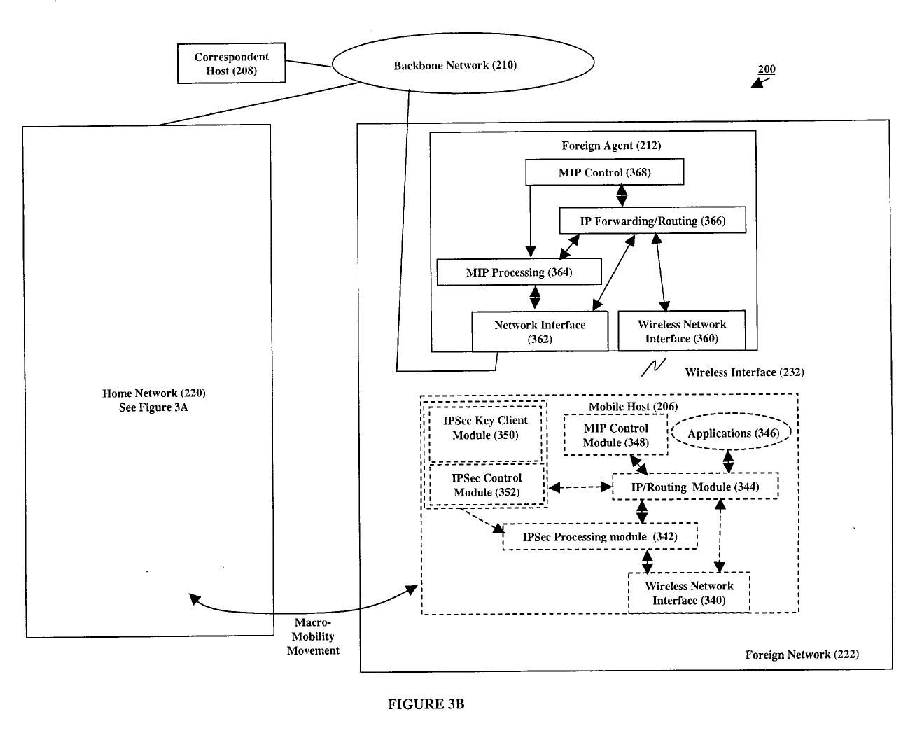

FIGS. 3A and 3B are a more detailed representation of our invention, showing in particular mobile host 206 (both in home network 220 and a foreign network 222), home agent 204, security gateway 202, and foreign agent 212. Mobile host 204 comprises a wireless network interface 340, 1P/routing module 344, MIP control module 348, and IPSec related modules including IPSec key client module 350, IPSec control module 352, and IPSec processing module 342. Wireless interface 340 provides the mobile host with wireless access to network 200. IP/routing module 344 performs IP layer processing. MIP control module 348 performs mobility management when mobile host 206 moves to foreign networks, such as network 222. IPSec key client module 350 is an optional module that communicates in an automated fashion with an IPSec key server/client module 314 (further described below) to obtain secure key information and security association management data relevant to secure communications with the security gateway 202. Alternatively, this information can be manually managed/configured. IPSec control module 352 performs IPSec configuration for the mobile host. Lastly, IPSec processing module 342 performs IPSec encryption/decryption and IPSec encapsulation. Applications 346 executing within mobile host 206 transmit/receive packets to from network 200 through IP processing module 344 and wireless interface 340. When security is required over a wireless interface 230, 232, and 234, the packets additionally pass through IPSec processing module 342.

Home agent 204 comprises at least two interfaces, including wireless interface 320 and network interface 322. Home agent 204 further comprises IP forwarding/routing module 326, MIP control module 328, and MIP processing module 324. Wireless interface 320 provides mobile host 206 wireless access to network 200. Network interface 322 interfaces with the home network 220, including security gateway 202. IP forwarding/routing module 326 routes packets between the wireless network interface 320 and the network interface 322. MIP control module 320 performs mobility management when mobile host 206 moves to/from the foreign networks. MIP processing module 324 performs MIP encapsulation of all packets from the correspondent host destined for the mobile host when the mobile host is in the foreign networks.

Security gateway 202 comprises at least two interfaces, including network interface 304 for interfacing with the home network 220, and network interface 302 for interfacing with the backbone network 210. In accordance with our invention, network interface 302 is the only point of access for home network 220 to the backbone network 210. Security gateway 202 further comprises IP forwarding/routing module 310, proxy ARP (address resolution protocol) module 308, and IPSec related modules including IPSec key server/client module 314, IPSec control module 312, and IPSec processing module 306. IP forwarding/routing module 310 routes packets between the backbone network, which is accessed through network interface 302, and home network 220, which is accessed through network interface 304. IPSec key server/client module 314 is a server for home network 220 that provides secure key information and security association management data required for the establishment of security associations between mobile hosts and the security gateway. For example, the IPSec key client module 350 within the mobile host 206 communicates in an automated fashion with the IPSec key server/client module 314 to obtain the information. Similarly, the IPSec key server/client module 314 is also a client module in that the security gateway obtains configuration information to establish the security associations. As an alternative to the IPSec key server/client module 314, the security associations can be managed/configured manually. Similar to the mobile host, IPSec control module 312 performs IPSec configuration for the security gateway and the IPSec processing module 306 performs IPSec encryption/decryption and IPSec encapsulation. In general, packets entering/leaving the home network 220 that do not require wireless security pass between network interfaces 302 and 304 and IP forwarding/routing module 310. Packets requiring secure communications additionally pass through IPSec processing module 306.

Proxy ARP module 308 is an optional module. Specifically, as indicated above, security gateway 202 passes traffic between the backbone network 210 and the home network 220. As such, security gateway 202 must be configured as a bridge, which is processing intensive, or as an IP router, which requires the network at network interface 304 be configured as a new IP sub-network that uses a new IP subnet number. To avoid the complexities of these options, a proxy ARP module 308 can be associated with network interface 302. This module is configured to respond to ARP requests from the backbone network for devices on home network 220, such home agent 204 and mobile host 206. Specifically, in response to ARP requests for the home agent and security gateway, the proxy ARP module responds with the security gateway's hardware address for network interface 302. As a result, packets from the correspondent host, for example, are routed to the security gateway network interface 302 and then onto the home network 220 through IP forwarding/routing module 310 and network interface 304.

Foreign agent 212 (FIG. 3B) is similar to home agent 204. Specifically, foreign agent 212 comprises at least two interfaces, including wireless network interface 360 that provides mobile host 206 wireless access to network 200 when located in the foreign network 222, and network interface 362, which interfaces with backbone network 210. Foreign agent 212 further comprises IP forwarding/routing module 366, MIP control module 368, and MIP processing module 364. IP forwarding/routing module 366 routes packets between the two network interfaces 362 and 360. MIP control module 368 works with mobile host 206 to perform mobility management with the home agent 204 when mobile host 206 moves to the foreign network 222. MIP processing module 324 performs MIP decapsulation, and optionally MIP encapsulation, of all packets encapsulated by the home agent originated by the correspondent host 208, for example, and forwards these decapsulated packets to the mobile host.

Reference will now be made to the interaction of the mobile host 206, home agent 204, security gateway 202, foreign agent 212, and correspondent host 208 (note that the correspondent host could also be a mobile device) to provide the mobile host 206 with secure communications over any wireless interface within network 200. As indicated with reference to FIG. 2 and in accordance with our invention, mobile host 206 and security gateway 202 establish a single tunnel mode security association using the permanent IP address assigned to the mobile host at wireless interface 340 and the IP address assigned to the security gateway at network interface 304. Note that such a security association is established between the security gateway and each mobile host associated with the home network 220 that requires/requests secure wireless communications. This single tunnel mode security association between the mobile host at interface 340 and the security gateway at interface 304 provides mobile host 206 with secure communications over any wireless interface 230, 232, and 234 in network 200 whether the mobile host is located in the home network 220 or a foreign network 222 and 224. As indicted, the security association can be established manually or, preferably, in an automated fashion with the IPSec key client module 350 on the mobile host communicating with the IPSec key server/client module 314 on the security gateway.

When mobile host 206 is in the home network 220 and communicating with the correspondent host 208, data from an application 346 passes through the IP/routing module 344 where the data is packetized with an IP header addressing the packet to correspondent host 208. The packet is then passed through IPSec processing module 342 where the packet is encrypted, IPSec encapsulated, and addressed to the security gateway at network interface 304. The packet is then securely transmitted over wireless interface 230 to the home agent at wireless network interface 320, where the packet is received and then forwarded to network interface 322 and to the security gateway at network interface 304. At the security gateway, the IPSec encapsulated packet is passed to the IPSec processing module 306 where the IPSec header is removed and the packet is decrypted revealing the original IP packet. The security gateway then forwards the original packet through network interface 302 to the correspondent host 208.

Similarly, IP packets generated by the correspondent host 208 are addressed to the mobile host 206 using the mobile host's permanent IP address at wireless network interface 340. As a result of the proxy ARP module, this packet is routed to the security gateway at network interface 302. The security gateway forwards the packet to the IPSec processing module 306 where the packet is encrypted, IPSec encapsulated, and addressed to the mobile host using the mobile host's permanent IP address. The packet is then transmitted on network interface 304 towards the home agent 204 at network interface 322. The home agent receives and then forwards the encrypted packet to wireless network interface 320 where the packet is securely transmitted to the mobile host at wireless network interface 340. At the mobile host, the IPSec encapsulated packet is passed to the IPSec processing module 342 where the IPSec header is removed and the packet decrypted revealing the original packet. The packet is then forwarded to an application 346.

When the mobile host 204 moves to foreign network 222, the security association with the security gateway 202 remains established. Specifically, the mobile host 204 initiates mobility upon entering the foreign network 222 by communicating with foreign agent 212, causing foreign agent 212 to register the mobile host's care-of-address with the home agent 204. During this time, the single tunnel mode security association using the permanent IP address assigned to the mobile host at wireless interface 340 and the IP address assigned to the security gateway at network interface 304 remains established.

While in the foreign network 222, data from an application 346 destined for correspondent host 208 is packetized and passed to IPSec processing module 344, where the packet is encrypted and IPSec encapsulated using the address of the security gateway at network interface 304 as the destination address. This packet is then securely transmitted over wireless interface 232 to the foreign agent 212 at wireless network interface 360. The foreign agent receives and forwards this encrypted packet to network interface 362 where network 210 routes the packet to the security gateway at network interface 304, the security gateway receiving the IPSec packet as if the mobile host 206 were in the home network. Upon realizing the packet is addressed to itself, the security gateway passes the packet to the IPSec processing module 306 where the IPSec header is removed and the packet decrypted revealing the original packet. The packet is then passed to the IP forwarding/routing module 310, which forwards the packet to network interface 302 where the packet is transmitted to correspondent host 208.

Note that if foreign agent 212 uses reverse MIP tunneling, upon receiving the IPSec packet from mobile host 206, the IP forwarding/routing module 366 at the foreign agent passes the packet to MIP processing module 364. This module further encapsulates the packet with a MIP header, addressing the packet to network interface 322 on home agent 204. This packet is then transmitted on network interface 362 and routed through backbone network 210 and security gateway 202 to network interface 322 at the home agent. The home agent passes this packet to MIP processing module 324 where the MIP header is removed, exposing the IPSec header, which has a destination address of network interface 304 at the security gateway. The home agent then forwards this packet to the security gateway using network interface 322, where the security gateway IPSec processes the packet as above and forwards the packet to correspondent host 208.

As for an IP packet generated by the correspondent host 208 when the mobile host is in foreign network 222, the correspondent host continues to address the packet to the mobile host 206 using the mobile host's permanent IP address. As above, this packet is routed to the security gateway at network interface 302, where the security gateway forwards the packet to the IPSec processing module 306. Again, the security gateway encrypts the packet, IPSec encapsulates the packet, and addresses the packet to the mobile host using the mobile host's permanent IP address. The security gateway then transmits the packet on network interface 304 towards the home agent 204 at network interface 322 as if the mobile host were still located in home network 220. Because the mobile host registered its mobility with the home agent 204, the home agent now forwards the received encrypted packet to MIP processing module 324 where the packet is encapsulated with a MIP header and addressed to the foreign agent at network interface 362. The mobile host then transmits this MIP encapsulated packet on network interface 322 towards the security gateway 202, where the packet is forwarded to the backbone network 210 and routed to the foreign agent 212. Upon receiving the packet, the foreign agent forwards the packet to MIP processing module 364 where the MIP header is removed exposing the IPSec packet addressed to the mobile host's permanent IP address. Accordingly, the foreign agent forwards the IPSec packet to wireless network interface 360 where the packet is securely transmitted over wireless interface 232 to wireless network interface 340 at mobile host 206. The mobile host passes the IPSec encapsulated packet to the IPSec processing module 342 where the IPSec header is removed and the packet decrypted revealing the original packet. The packet is then forwarded to an application 346.

Advantageously, in accordance with our inventive security gateway 202 within home network 220, mobile host 206 transmits and receives secure communications over any wireless interface in network 200 through a single security association. Contrary to other solutions, mobile host 206 is not required to maintain numerous security associations with every correspondent host, such as correspondent host 208, to which the mobile host may communicate. As such, scalability issues and issues related to whether a correspondent host is running IPSec are not a concern. Similarly, the mobile host is not required to maintain a security association with every foreign network to which it may travel, again, overcoming scalability and trust concerns related to prior solutions. In addition and in accordance with our invention, a single security association is required between security gateway 202 and mobile host 206 and this security association remains active regardless of whether the mobile host travels to/from home network 220. As such, the mobile host does not encounter delays associated with removing and establishing security associations during mobility. The security association remains in place during mobility registration and deregistration. Furthermore, our inventive methods do not require modification to mobility protocols. Nor do our inventive methods require modification to security protocols.

A further advantage of our invention is that because the security gateway is localized within a home network, secure key information and security association management data can be managed in an efficient and secure form. Prior systems required network-wide automated systems, which automated systems do not currently exist in an efficient and secure form.

The above-described embodiments of our invention are intended to be illustrative only. Numerous other embodiments may be devised by those skilled in the art without departing from the spirit and scope of our invention.

We claim:

1. A security gateway for a wireless communications network that comprises a home network and a plurality of foreign networks, the home and foreign networks being interconnected by a backbone network, the security gateway comprising:
at least two network interfaces wherein the first interface is intended to be connected to the backbone network and the second interface is intended to be connected to the home network and wherein the security gateway provides the only point of access to the home network;
a routing module for forwarding data packets between the first and the second interfaces; and
a security processing module wherein the security processing module maintains a single tunnel mode security association with a mobile host intended to be associated with the home network and wherein the intended single tunnel mode security association with the mobile host provides the mobile host with secure communications over any wireless interface through which the mobile host communicates in the wireless network.

2. The security gateway of claim 1 further comprising a security server module, which provides the mobile host with security association management data and secure keys for the mobile host's intended security association.

3. The security gateway of claim 1 wherein the security processing module maintains a plurality of single tunnel mode security associations with a plurality of mobile hosts.

4. A wireless communications network comprising:
a home network with one or more wireless interfaces for providing access to a mobile host associated with the home network;
a plurality of foreign networks each comprising one or more wireless interfaces for providing access to the mobile host when the mobile host moves to the foreign networks; and
a backbone network interconnecting the home network and plurality of foreign networks;
said home network including a security gateway that interfaces the home network to the backbone network, wherein the security gateway comprises a security processing module that maintains a single tunnel mode security association with the mobile host and wherein the single tunnel mode security association provides the mobile host with secure communications over the home network wireless interfaces and the wireless interfaces of the plurality of foreign networks.

5. The wireless communications network of claim 4 wherein the home network comprises a home agent with a mobility management protocol that assists the mobile host in moving between the home network and foreign networks.

6. The wireless communications network of claim 5 wherein the mobility management protocol is Mobile IP (Internet Protocol) and the security processing module executes IPSec.
